(19) United States
(12) Patent Application Publication
(10) Pub. No.: US 2026/0181434 A1
(43) Pub. Date: Jun. 25, 2026

(54) MOBILITY MANAGEMENT METHOD AND DEVICE FOR PUBLIC TERMINAL PERFORMING BEAMFORMING IN WIRELESS COMMUNICATION SYSTEM

(71) Applicant: SAMSUNG ELECTRONICS CO., LTD., Suwon-si, Gyeonggi-do (KR)

(72) Inventors: Kyoungmin PARK, Suwon-si (KR); Hyunseok RYU, Suwon-si (KR); Jaewon LEE, Suwon-si (KR)

(21) Appl. No.: 19/128,937

(22) PCT Filed: Nov. 9, 2023
(86) PCT No.: PCT/KR2023/017992

§ 371 Date: May 9, 2025

(30) Foreign Application Priority Data
Nov. 10, 2022 (KR) 10-2022-0150007

(51) Int. Cl. H04W 24/08; H04L 5/00; H04W 24/10

(52) U.S. Cl. CPC H04W 24/08; H04L 5/0048; H04W 24/10

(57) ABSTRACT

The disclosure relates to a 5G or 6G communication system for supporting a higher data transmission rate. This operating method of a terminal in a wireless communication system may comprise the steps of: determining a list of one or more neighboring cells in which inter-cell interference can occur, and one or more beams for measuring a channel state of the one or more neighboring cells; measuring the channel state of the one or more neighboring cells on the basis of the one or more beams; selecting a list of candidate cells on the basis of result values of the measurement; and transmitting, to a base station, a message containing the list of candidate cells and information about the one or more beams.

### TECHNICAL FIELD

The disclosure relates to operations of a UE and a base station in a wireless communication system and, more particularly, to a method in which an aerial UE measures and reports beam information and multi-cell information in a wireless communication system, and an apparatus therefor.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Based on the above discussion, the disclosure may provide an apparatus and a method for enabling an aerial UE to measure and report beam information and multi-cell information in a wireless communication system.

More specifically, the disclosure may provide a method and an apparatus for simultaneously controlling beams of an aerial UE having a beam generating function and controlling the access of the aerial UE to a base station in a wireless communication system. In addition, the disclosure may prevent a method wherein an aerial UE generates and reports received beam information and discovered cell or base station information, and may prevent a method wherein a network controller or a base station which constitutes a terrestrial network assigns a base station or a cell to an aerial UE, based on reported information.

### Solution to Problem

In order to solve the above-mentioned problems, a method for operating a terminal in a wireless communication system according to the disclosure may include: determining a list of at least one adjacent cell between which inter-cell interference may occur, and at least one beam for measuring the channel status regarding the at least one adjacent cell; measuring the channel status regarding the at least one adjacent cell, based on the at least one beam; selecting a candidate cell list, based on the measurement result value; and transmitting a message including the candidate cell list and information regarding the at least one beam to a base station.

In order to solve the above-mentioned problems, a method for operating a base station in a wireless communication system according to the disclosure may include: transmitting a list of at least one adjacent cell between which inter-cell interference may occur, and configuration information regarding at least one beam for measuring the channel status regarding the at least one adjacent cell to a terminal; and receiving a candidate cell list and information regarding the at least one beam from the terminal, wherein the channel status regarding at least one adjacent cell is measured based on the at least one beam, and the candidate cell list may be determined based on the measurement result value.

In order to solve the above-mentioned problems, a terminal in a wireless communication system according to the disclosure may include at least one transceiver and at least one processor functionally coupled to the at least one transceiver. The at least one processor may be configured to: configure a list of at least one adjacent cell between which inter-cell interference may occur, and at least one beam for measuring the channel status regarding the at least one adjacent cell; measure the channel status regarding the at least one adjacent cell, based on the at least one beam; determine a candidate cell list, based on the measurement result value; and transmit the candidate cell list and information regarding the at least one beam to a base station.

In order to solve the above-mentioned problems, a base station in a wireless communication system according to the disclosure may include at least one transceiver and at least one processor functionally coupled to the at least one transceiver. The at least one processor may be configured to: transmit a list of at least one adjacent cell between which inter-cell interference may occur, and configuration information regarding at least one beam for measuring the channel status regarding the at least one adjacent cell to a terminal; and receive a candidate cell list and information regarding the at least one beam from the terminal. The channel status regarding at least one adjacent cell may be measured based on the at least one beam, and the candidate cell list may be determined based on the measurement result value.

### Advantageous Effects of Invention

The disclosure can provide an apparatus and a method capable of effectively providing services in a wireless communication system.

The disclosure may provide a method and an apparatus wherein an aerial UE reports the UE's beam information to a base station directly and/or indirectly in a wireless communication system, and effectively reports information regarding a change in inter-cell interference caused by beam generation, or generation of inter-cell interference regarding each beam, to the base station.

The disclosure may provide a method and an apparatus wherein a base station or a network maintains an appropriate level of link quality of an aerial UE, based on information reported by the aerial UE, and efficiently control downlink interference (uplink interference) in a wireless communication system, thereby increasing the overall cell throughput and performing cell load balancing.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a wireless communication system according to various embodiments of the disclosure.

FIG. 2 illustrates a structure of a base station in a wireless communication system according to various embodiments of the disclosure.

FIG. 3 illustrates a structure of a UE in a wireless communication system according to various embodiments of the disclosure.

FIG. 4 illustrates a vertical beam radiation pattern of a base station antenna used in a terrestrial network according to various embodiments of the disclosure.

FIG. 5 illustrates one aerial UE according to various embodiments of the disclosure, which causes interference to multiple base stations.

FIG. 6 illustrates saturation of the communication capacity of a terrestrial base station or cell due to a movement or handover of an aerial UE according to various embodiments of the disclosure.

FIG. 7 illustrates an operation of removing inter-cell interference by beamforming of an aerial UE according to various embodiments of the disclosure.

FIG. 8 illustrates the limitations of ICI control by beamforming of an aerial UE according to various embodiments of the disclosure.

FIG. 9 illustrates the order in which an aerial UE reports measurement cell-specific beam information according to various embodiments of the disclosure.

FIG. 10 illustrates the order in which an aerial UE reports partial information regarding measurement cell-specific beams according to various embodiments of the disclosure.

FIG. 11 illustrates the order in which an aerial UE reports indirect information regarding measurement cell-specific beams according to various embodiments of the disclosure.

FIG. 12 illustrates the order in which an aerial UE reports indirect information regarding measurement cell-specific beams according to various embodiments of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors and/or devices.

In the following description, some of terms and names defined in the 3rd generation partnership project long term evolution (3GPP LTE)-based communication standards (e.g., standards for 5G, NR, LTE, and similar systems) may be used for the sake of descriptive convenience. However, the disclosure is not limited by these terms and names, and may be applied in the same way to systems that conform other standards.

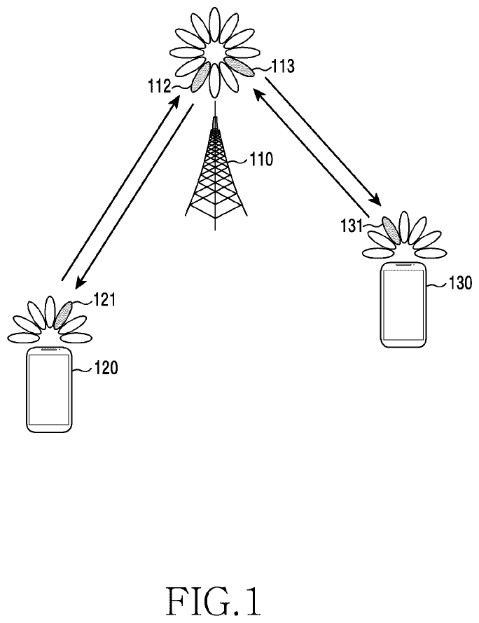

FIG. 1 illustrates a wireless communication system according to various embodiments of the disclosure. FIG. 1 illustrates a base station 110, a UE 120, and a UE 130 as some of nodes using a radio channel in the wireless communication system. Although FIG. 1 illustrates only one base station, other base stations identical or similar to the base station 110 may be further included.

The base station 110 is a network infrastructure that provides the UEs 120 and 130 with radio access. The base station 110 has coverage defined as a certain geographical area, based on a distance over which a signal can be transmitted. The base station 110 may be referred to as an access point (AP), an eNodeB (eNB), a 5th-generation (5G) node, a next-generation nodeB (gNB), a wireless point, a transmission/reception point (TRP), or other terms with equivalent technical meanings, in addition to a base station.

Each of the UE 120 and the UE 130 is a device used by a user and performs communication with the base station 110 through a wireless channel. In some cases, at least one of the UE 120 and the UE 130 may be operated without a user's involvement. That is, at least one of the UE 120 and the UE 130 may be a device performing machine-type communication (MTC), and may not be carried by a user. Each of the UE 120 and the UE 130 may be referred to as a terminal, a mobile station, a subscriber station, a remote terminal, a wireless terminal, a user device, or other terms with equivalent technical meanings, in addition to a UE.

The base station 110, the UE 120, and the UE 130 may transmit and receive wireless signals in millimeter wave (mmWave) bands (e.g., 28 GHz, 30 GHz, 38 GHz, 60 GHz). In this regard, in order to improve a channel gain, the base station 110, the UE 120, and the UE 130 may perform beamforming. The beamforming may include transmission beamforming and reception beamforming. That is, the base station 110, the UE 120, and the UE 130 may apply directivity to transmission signals or reception signals. To this end, the base station 110 and the UEs 120 and 130 may select serving beams 112, 113, 121, and 131 via a beam search procedure or a beam management procedure. After the serving beams 112, 113, 121, and 131 are selected, subsequent communication may be performed through a resource having a quasi co-located (QCL) relationship with a resource through which the serving beams 112, 113, 121, and 131 have been transmitted.

If large-scale characteristics of a channel, via which a symbol on a first antenna port has been transferred, can be inferred from a channel via which a symbol on a second antenna port has been transferred, it may be evaluated that the first antenna port and the second antenna port are in a QCL relationship. For example, the large-scale characteristics may include at least one of a delay spread, a Doppler spread, a Doppler shift, average gain, an average delay, and a spatial receiver parameter.

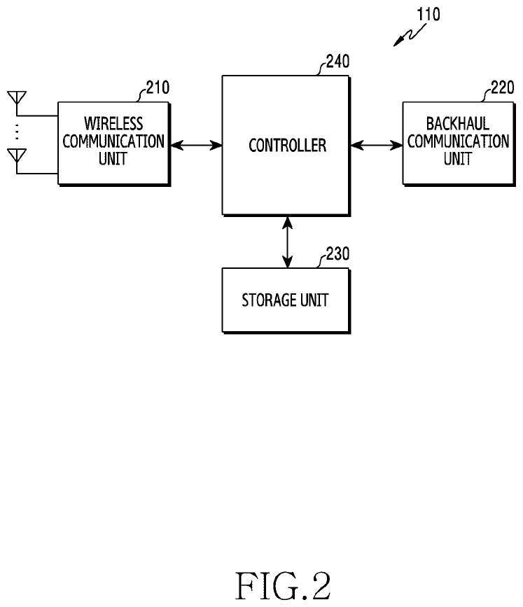

FIG. 2 illustrates a structure of a base station in a wireless communication system according to various embodiments of the disclosure. The structure illustrated in FIG. 2 may be understood as a structure of the base station 110. As used herein, the term “ . . . unit”, “ . . . er”, or the like refers to a unit configured to process at least one function or operation, and may be implemented as hardware, software, or a combination of hardware and software.

Referring to FIG. 2, the base station includes a wireless communication unit 210, a backhaul communication unit 220, a storage unit 230, and a controller 240.

The wireless communication unit 210 performs functions for transmitting/receiving signals through radio channels. For example, the wireless communication unit 210 performs functions of conversion between baseband signals and bitstrings according to the physical layer specifications of the system. For example, during data transmission, the wireless communication unit 210 generates complex symbols by encoding and modulating a transmission bitstream. In addition, during data reception, the wireless communication unit 210 restores a reception bitstream by demodulating and decoding a baseband signal.

In addition, the wireless communication unit 210 up-converts a baseband signal to an RF band signal, transmits the same through an antenna, and down-converts an RF band signal received through the antenna to a baseband signal. To this end, the wireless communication unit 210 may include a transmission filter, a reception filter, an amplifier, a mixer, an oscillator, a digital to analog converter (DAC), an analog to digital converter (ADC), and the like. In addition, the wireless communication unit 210 may include multiple transmission/reception paths. Furthermore, the wireless communication unit 210 may include at least one antenna array including multiple antenna elements.

In view of hardware, the wireless communication unit 210 may be configured by a digital unit and an analog unit, and the analog unit may be configured by multiple sub-units according to operating power, operating frequency, etc. The digital unit may be implemented as at least one processor (e.g., a digital signal processor (DSP)).

The wireless communication unit 210 transmits and receives signals as described above. Accordingly, all or part of the wireless communication unit 210 may be referred to as a “transmitter”, a “receiver”, or a “transceiver”. In addition, as used in the following description, the meaning of “transmission and reception performed through a radio channel” includes the meaning that the above-described processing is performed by the wireless communication unit 210.

The backhaul communication unit 220 provides an interface for performing communication with other nodes in the network. That is, the backhaul communication unit 220 converts, into a physical signal, a bitstream transmitted from the base station to another node, for example, another access node, another base station, a higher node, a core network, etc., and converts a physical signal received from another node into a bitstream.

The storage unit 230 stores data such as basic programs, application programs, and configuration information for operations of the base station. The storage unit 230 may include a volatile memory, a nonvolatile memory, or a combination of a volatile memory and a nonvolatile memory. In addition, the storage unit 230 provides the stored data at the request of the controller 240.

The controller 240 controls the overall operation of the base station. For example, the controller 240 transmits and receives signals through the wireless communication unit 210 or the backhaul communication unit 220. In addition, the controller 240 records data in the storage 230 and reads the data from the storage 230. Furthermore, the controller 240 may perform functions of protocol stacks required by communication specifications. According to another embodiment, the protocol stack may be included in the wireless communication unit 210. To this end, the controller 240 may include at least one processor.

For example, the controller 240 may control the UE to perform operations according to various embodiments described below.

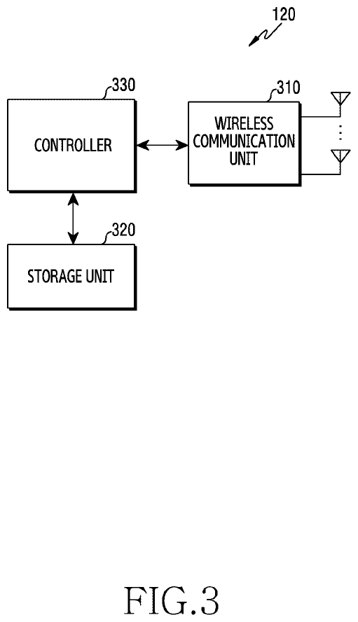

FIG. 3 illustrates a structure of a UE in a wireless communication system according to various embodiments of the disclosure. The structure illustrated in FIG. 3 may be understood as a structure of the UE 120. As used herein, the term “ . . . unit”, “ . . . er”, or the like refers to a unit configured to process at least one function or operation, and may be implemented as hardware, software, or a combination of hardware and software.

Referring to FIG. 3, the UE may include a communication unit 310, a storage unit 320, and a controller 330.

The communication unit 310 performs functions for transmitting/receiving signals through radio channels. For example, the communication unit 310 performs functions of conversion between baseband signals and bitstrings according to the physical layer specifications of the system. For example, during data transmission, the communication unit 310 generates complex symbols by encoding and modulating a transmission bitstream. When receiving data, the communication unit 310 restores a reception bitstream by demodulating and decoding a baseband signal. In addition, the communication unit 310 up-converts a baseband signal to an RF band signal, transmits the same through an antenna, and down-converts an RF band signal received through the antenna to a baseband signal. For example, the communication unit 310 may include a transmission filter, a reception filter, an amplifier, a mixer, an oscillator, a DAC, an ADC, etc.

In addition, the communication unit 310 may include multiple transmission and/or reception paths. Moreover, the communication unit 310 may include at least one antenna array configured by multiple antenna elements. In terms of hardware, the communication unit 310 may include a digital circuit and an analog circuit (e.g., a radio frequency integrated circuit (RFIC)). The digital circuit and the analog circuit may be implemented as a single package. In addition, the communication unit 310 may include multiple RF chains. Furthermore, the communication unit 310 may perform beamforming.

The communication unit 310 transmits and receives signals as described above. Accordingly, all or part of the communication unit 310 may be referred to as a “transmitter”, a “receiver”, or a “transceiver”. In addition, as used in the following description, the meaning of “transmission and reception performed through a radio channel” may include the meaning that the above-described processing is performed by the communication unit 310.

The storage unit 320 stores data such as basic programs, application programs, and configuration information for operations of the UE. The storage unit 320 may be configured by a volatile memory, a nonvolatile memory, or a combination of a volatile memory and a nonvolatile memory. In addition, the storage unit 320 provides the stored data at the request of the controller 330.

The controller 330 controls the overall operation of the UE. For example, the controller 330 transmits and receives signals via the communication unit 310. In addition, the controller 330 records data in the storage 320 and reads the data from the storage unit 320. In addition, the controller 330 may perform functions of protocol stacks required by communication specifications. To this end, the controller 330 may include at least one processor or microprocessor, or may be a part of a processor. In addition, a part of the communication unit 310 and the controller 330 may be referred to as a communication processor (CP).

For example, the controller 330 may control the UE to perform operations according to various embodiments described below.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

Hereinafter, the disclosure relates to a method and a device for supporting aerial communication represented by an unmanned aerial vehicle (UAV), urban air mobility (UAM), and the like in a wireless communication system.

Schemes for utilizing existing terrestrial networks for aerial communication for the purpose of supporting a wide service coverage, stable remote control, and various additional services have been considered, and 3GPP has been standardizing schemes for supporting UAV communication by using LTE terrestrial networks.

In Rel-18, 3GPP has been standardizing schemes for supporting aerial communication through NR terrestrial networks, and it is expected to standardize schemes for improving the mobility of aerial user equipment (UE), technology for identifying and tracking aerial UEs, and the like, as the schemes for supporting aerial communication. As used herein, the aerial UE may refer to a UE which is positioned not on the ground, but in the air. For example, the aerial UE may refer to an unmanned aircraft such as the above-mentioned UAV, UAM, or drone.

3GPP is currently considering a scheme in which existing communication networks (for example, terrestrial communication networks) are reused as a scheme for supporting communication, and base stations that constitute existing communication networks (for example, terrestrial communication networks) may be implemented to use link access through side beams of sidelobes of the base stations, instead of link access through the main beam or main lobe.

An array antenna system may use a scheme in which the link reliability is increased through directivity gain, and a high level of directivity gain may be secured by minimizing the power and energy leaked (or lost) through the sidelobes. For example, sidelobes may typically have a narrow beam width and a low beamforming gain. Therefore, the more excellent the array antenna or the more precise the directional antenna, the lower the beam width and beamforming gain of the sidelobes.

Due to the above-described characteristics of the sidelobes, aerial communication considered by 3GPP may solely support low link quality. As used herein, the link quality may have the same meaning as a channel status. In addition, due to the characteristics of sidelobes generate multiple narrow beams in various uncontrolled directions, the aerial link considered in 3GPP may cause interference with regard to multiple base stations or terrestrial cells.

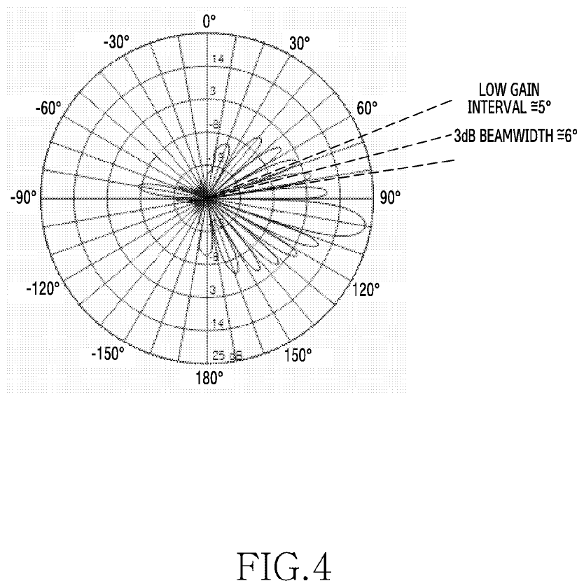

FIG. 4 illustrates a vertical beam radiation pattern of a base station antenna used in a terrestrial network according to various embodiments of the disclosure.

Referring to FIG. 4, an example of the beam gain of the vertical component of an array antenna used in a terrestrial base station may be described, and the beam gain of the vertical component of the array antenna may represent a beam pattern used for the study of LTE-based aerial communication of 3GPP. The procedure of communication of an aerial UE (for example, UAV) is as follows: during downlink transmission, the transmission of data (for example, UE control information) that requires a low data rate is the major service target, but during uplink transmission, transmission of data (for example, video stream transmission) that requires a higher data rate than the downlink transmission may be the major service target. 3GPP is currently researching a scheme for supporting aerial communication, which has different service requirements from the above-described procedure of communication of an aerial UE, through a ground network. According to 3GPP research results, in case that a UE is positioned in the air, a line of sight (LoS) environment may be established between the aerial UE and multiple base stations. However, in case of performing aerial communication in the LoS environment through a sidelobe, transmission of aerial uplink data may cause serious interference with regard to multiple cells.

For example, in the vertical beam radiation pattern of a base station antenna used in a terrestrial network, the low gain interval resulting from sidelobes distributed around the main lobe may appear at a vertical interval of about 5°. In addition, sidelobes having a beamwidth size of 3 dB may appear at a vertical interval of about 6°.

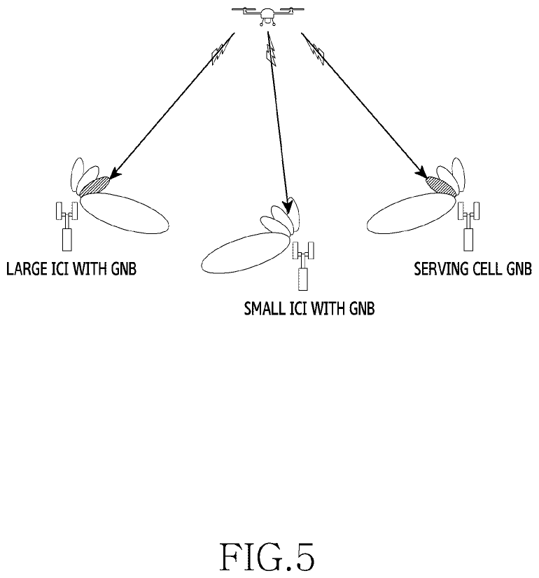

FIG. 5 illustrates one aerial UE according to various embodiments of the disclosure, which causes interference to multiple base stations.

Referring to FIG. 5, an example in which the performance of a terrestrial UE is degraded by an aerial UE may be described. For example, one aerial UE may cause interference to multiple base stations. In addition, since the existing terrestrial network has been configured for the purpose of supporting terrestrial UEs or terrestrial users, an aerial UE's attempt to access a specific terrestrial network may cause a problem related to cell capacity. As used herein, a specific terrestrial network may refer to a terrestrial network configured in a situation in which there is insufficient consideration of aerial traffic (for example, a case in which there is no prior information regarding beams transmitted from the aerial UE). For example, in case that an aerial UE approaches the terrestrial network or attempts to access the same after the terrestrial network has depleted the entire communication capacity in order to support terrestrial UEs, existing terrestrial UEs or terrestrial uses may undergo serious degradation in communication performance.

Referring back to FIG. 5, in case an aerial UE transmits signals near a terrestrial base station which has already depleted the communication capacity, inter-channel/carrier interference (ICI) may occur in multiple terrestrial base stations, including the terrestrial base station that has depleted the communication capacity. As used herein, ICI may refer to inter-frequency interference occurring between adjacent or identical channels/carriers. In one embodiment, in case that a specific terrestrial base station has received signals transmitted from one sidelobe and the aerial UE at the same angle, a large amount of ICI may occur in the base station. In one embodiment, in case that a specific terrestrial base station has received signals transmitted from one sidelobe and the aerial UE at different angles, a small amount of ICI may occur in the base station. The base station in which ICI may occur may also refer to the base station of the serving cell that provides a communication service to the aerial UE.

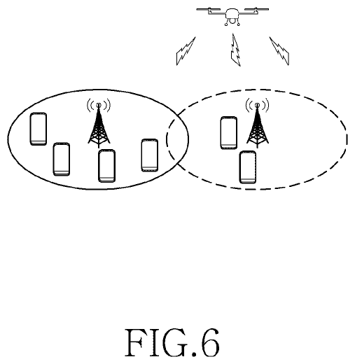

FIG. 6 illustrates saturation of the communication capacity of a terrestrial base station or cell due to a movement or handover of an aerial UE according to various embodiments of the disclosure.

Referring to FIG. 6, an example in which the performance of a terrestrial UE is degraded by an aerial UE. For example, the communication capacity of a terrestrial base station or cell may be saturated by the aerial UE's handover. In an embodiment, the aerial UE's movement in the atmosphere may change the cell that provides a communication service to the aerial UE. Therefore, the aerial UE may hand over from the serving cell which has previously been providing a communication service to a target cell which provides a communication service at a changed location. In case that the target cell or the base station in the target cell has depleted the entire communication capacity to support the newly accessed aerial UE, the terrestrial base station may not be able to support the handover of terrestrial UEs any longer. It is the general situation that terrestrial UEs can receive stable services only through a small number of base stations. Therefore, in case that some terrestrial base stations cannot support the handover of terrestrial UEs as described above, terrestrial UEs or terrestrial users near corresponding base stations may undergo serious degradation in communication performance.

Therefore, as a scheme for reducing interference by the aerial UE and efficiently controlling the aerial UE's cell access, it may be proposed that the aerial UE be endowed with beamforming capability. In an embodiment, the aerial UE may generate beams for transmitting and/or receiving signals with one base station, and may reduce interference occurring in other base stations through the beam generation. Alternatively, the aerial UE may remove interference occurring in other base stations. As used herein, other base stations may refer to at least one base station other than the base station that transmits and/or receives signals with the aerial UE. In an embodiment, other base stations may refer to base stations which have depleted the entire communication capacity to provide communication services to terrestrial UEs (for example, at least one of the base stations in which ICI occurs in FIG. 5). In an embodiment, other base stations may refer to target base stations which have depleted the entire communication capacity to provide communication services to terrestrial UEs (for example, base stations in the target cell in FIG. 6).

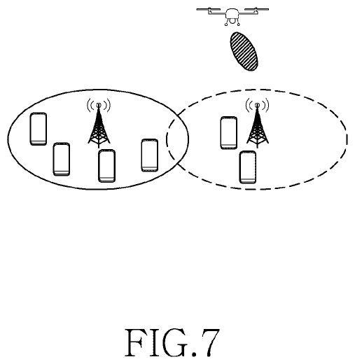

FIG. 7 illustrates an operation of removing inter-cell interference by beamforming of an aerial UE according to various embodiments of the disclosure.

Referring to FIG. 7, an example of a method for removing inter-cell interference by beamforming of an aerial UE may be described. The aerial UE may communicate with one base station, and may simultaneously generate a beam that can remove signals transmitted to other base stations. The aerial UE may control the occurrence of inter-cell interference through the beam generated to remove signals transmitted to other base stations. However, it may be difficult to expect highly efficient inter-cell interference control in an actual communication system through the method in which the UE generates beams to remove signals transmitted to other base stations.

According to the physical characteristics of antennas, the width of a main beam generated by an array antenna or a directional antenna may vary depending on at least one of the size of the array antenna or the performance of the directional antenna (for example, the amount of power that can be radiated in a specific direction). In addition, the beam width of main lobes generated by the array antenna or directional antenna may be larger than the beam width of sidelobes. Furthermore, the performance of antennas used in base stations may be superior to that of antennas applied to UE. Accordingly, the beam width of main lobes generated by aerial UEs may be larger than the beam width of sidelobes generated the base stations. Therefore, respective beams generated by an aerial UE are configured to be used for communication with one or more base stations, and it may thus be difficult for the UE beamforming technology to completely remove inter-cell interference.

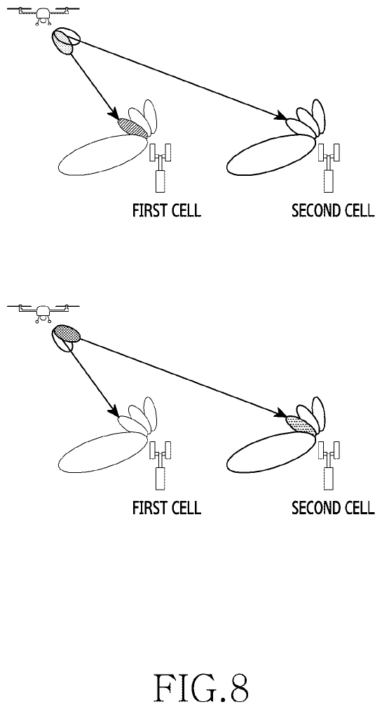

FIG. 8 illustrates the limitations of ICI control by beamforming of an aerial UE according to various embodiments of the disclosure.

Referring to FIG. 8, the aerial UE may generate at least one of a beam for accessing the first cell or a beam for accessing the second cell. However, both the base station in the first cell and the base station in the second cell may receive signals transmitted by the aerial UE. For example, the base station in a first cell may receive beams generated for the base station in the second cell, transmitted by the aerial UE, and the base station in the second cell may receive beams generated for the base station in the first cell, transmitted by the aerial UE. Therefore, inter-cell interference may occur if the base station in one cell receives beams generated by the aerial UE to be transmitted to the base station in the other cell. Particularly, in case that the aerial UE attempts to access the second cell generated by the base station located at a relatively long distance, the aerial UE may use higher transmission power to counterbalance signal attenuation caused by the distance. Therefore, due to the high transmission power of beams to be transmitted to the base station in the second cell, the beams may result in stronger inter-cell interference to the first cell.

In the above-described embodiments, beamforming of the aerial UE may be effective only in cases in which the aerial UE uses appropriate beams to access respective cells, and may otherwise degrade the performance of existing terrestrial communication. Therefore, the disclosure may propose a method of reporting information regarding a beam to be used in case that the aerial UE attempts to access a specific base station, to the base station. By means of the information regarding a beam to be used in case that the aerial UE attempts to access a specific base station, the base station may predict the occurrence of inter-cell interference resulting from the aerial UE's terrestrial network access in advance. In addition, based on the information regarding a beam to be used in case that the aerial UE attempts to access a specific base station, the base station may efficiently control the aerial UE's terrestrial network access. The base station may be a terrestrial base station included in the terrestrial network.

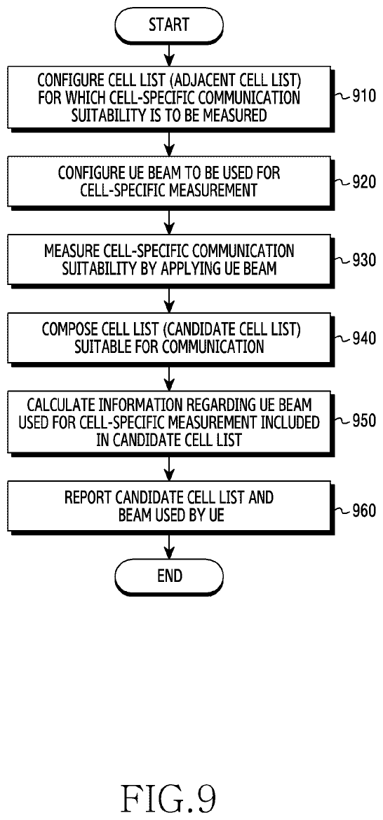

In an embodiment, the aerial UE may report direct information regarding the beam to be used for communication with each cell to the base station. For example, information regarding the beam shape to be used when the aerial UE accesses each cell may be transmitted to the base station. The base station may predict ICI that can occur, based on the information regarding the beam shape to be used when the aerial UE accesses each cell. The order of operation of the aerial UE regarding an embodiment in which the aerial UE reports information regarding the beam used to measure channel or cell information will hereinafter be described in detail with reference to FIG. 9. Hereinafter, the procedure in which the aerial UE reports information regarding the beam used to measure channel or cell information may be referred to as the aerial UE's beam information reporting procedure.

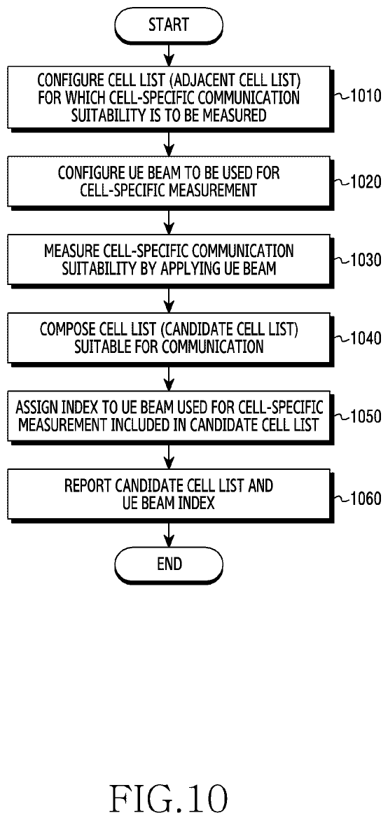

In an embodiment, the aerial UE may report partial information regarding the beam to be used for communication with each cell to the base station. For example, in connection with reporting multiple communicable or accessible cells to the base station, the aerial UE may report the similarity and/or differentiability between UE beams to be used for cell-specific communication. Based on the similarity between beams received from the aerial UE, the base station may infer information regarding cells which are to be affected by ICI in case that the UE accesses each cell. The base station may also use the information regarding cells which are to be affected by ICI for the aerial UE's access control. The order of operation of the aerial UE regarding an embodiment in which the aerial UE reports partial information regarding the beam used for communication with each cell to the base station will hereinafter be described in detail with reference to FIG. 10.

In an embodiment, the aerial UE may report indirect information regarding the beam to be used for communication with each cell to the base station. For example, in case that the aerial UE uses a specific beam selected by a specific beam or aerial UE, the aerial UE may report at least one of information regarding communicable or accessible cells or information regarding cells which may cause the effect of IC removal (or reduction) in case that the same beam is used, to the base station. Therefore, the aerial UE may not report detailed information regarding the beam used (or to be used) for communication with the base station, and the base station may acquire inter-cell interference information which follows the aerial UE's terrestrial network access, without direction information regarding the aerial UE's beam.

The aerial UE's operations for reducing the inter-cell interference are not limited to the above-described embodiments. In addition, operations of the aerial UE are not limited to one of the above-described embodiments. Therefore, the aerial UE may operate according to a combination of two or more of the above-described embodiments.

FIG. 9 illustrates the order in which an aerial UE reports measurement cell-specific beam information according to various embodiments of the disclosure.

Referring to FIG. 9, detailed operations of the procedure in which the aerial UE reports beam information may be described.

In step 910, the aerial UE may be configured to report communication suitability (for example, link quality) to a base station with regard to multiple cells for which communication suitability is to be measured. A cell list regarding multiple cells for which communication suitability is to be measured by the aerial UE may refer to a list of adjacent cells between which inter-cell interference may occur. In an embodiment, configurations for reporting communication suitability may be made by the base station through at least one of upper layer signaling (for example, radio resource control (RRC) message) or MAC layer signaling (for example, media access control (MAC) control element (CE)) or control information (for example, downlink control channel (DCI)). Information may be configured for the UE as a list of adjacent cells (for example, a list of candidate target cells to which the aerial UE is to hand over), and the list of adjacent cells may be determined by the base station. In an embodiment, the aerial UE may directly compose a list of adjacent cells for which communication suitability will be measured and reported. The aerial UE may transmit the composed list of adjacent cells to the base station.

In step 920, the aerial UE may configure the aerial UE's beam to be used to measure communication suitability with regard to each cell for which communication suitability is to be measured. In an embodiment, the aerial UE may be configured to use a different reception beam with regard to each cell in connection with measuring communication suitability regarding each cell. In an embodiment, the aerial UE may be configured to at least one reception beam to the same cell.

In step 930, the aerial UE may measure communication suitability with regard to multiple cells. The aerial UE may use the beam configured according to an embodiment in step 920 in connection with measuring communication suitability (for example, reference signals received power (RSRP)).

In step 940, the aerial UE may compose a list of cells suitable for communication (for example, a candidate cell list) based on the result value measured in step 930. For example, the candidate cell list may include cells having values equal to or larger than a specific threshold value regarding communication suitability, among measurement result values. However, the candidate cell list is not limited to cases in which cells have values equal to or larger than a specific threshold value, and may also refer to cases in which cells have values equal to or smaller than a specific threshold value, depending on the type of the specific threshold value.

In step 950, the aerial UE may calculate information regarding the aerial UE's beam used for measurement with regard to each cell included in the candidate cell list (for example, information regarding the beam shape). In an embodiment, information regarding the aerial UE's beam used to measure communication suitability may be information regarding the beam shape, including at least one of the direction of the beam used by the aerial UE or the beam width. In an embodiment, information regarding the aerial UE's beam used to measure communication suitability may be information regarding signaling processing applied for beam generation (for example, beam vector information).

In step 960, the aerial UE transmit a report including the candidate cell list to the base station. The measurement information may include information regarding the beam used to measure communication suitability. In an embodiment, in case that the aerial UE has measured communication suitability by applying multiple reception beams to one cell (for example, step 930), the aerial UE may report beam information regarding one beam, among measurement values obtained by applying multiple reception beams, and the measurement result (for example, candidate cell list). In an embodiment, among the measurement results obtained by applying multiple reception beams, measurement results regarding multiple reception beams may be reported to the base station. Therefore, in connection with reporting communication suitability regarding one cell, the aerial UE may report multiple measurement results obtained by applying different beams.

FIG. 10 illustrates the order in which an aerial UE reports partial information regarding measurement cell-specific beams according to various embodiments of the disclosure.

Referring to FIG. 10, the order of operations of an aerial UE in which the aerial UE reports partial information regarding beams to be used for communication with respective cells may be described.

In step 1010, the aerial UE may be configured to report communication suitability (for example, link quality) to a base station with regard to multiple cells for which communication suitability is to be measured. A cell list regarding multiple cells for which communication suitability is to be measured by the aerial UE may refer to a list of adjacent cells between which inter-cell interference may occur. In an embodiment, configurations for reporting communication suitability may be made by the base station through at least one of upper layer signaling (for example, RRC message) or MAC layer signaling (for example, MAC CE) or control information (for example, DCI). Information may be configured for the UE as a list of adjacent cells (for example, a list of candidate target cells to which the aerial UE is to hand over), and the list of adjacent cells may be determined by the base station. In an embodiment, the aerial UE may directly compose a list of adjacent cells for which communication suitability will be measured and reported. The aerial UE may transmit the composed list of adjacent cells to the base station.

In step 1020, the aerial UE may configure the aerial UE's beam to be used to measure communication suitability with regard to each cell for which communication suitability is to be measured. In an embodiment, the aerial UE may be configured to use a different reception beam with regard to each cell in connection with measuring communication suitability regarding each cell. In an embodiment, the aerial UE may be configured to at least one reception beam to the same cell.

In step 1030, the aerial UE may measure communication suitability with regard to multiple cells. The aerial UE may use the beam configured according to an embodiment in step 1020 in connection with measuring communication suitability (for example, RSRP).

In step 1040, the aerial UE may compose a list of cells suitable for communication (for example, a candidate cell list) based on the result value measured in step 1030. For example, the candidate cell list may include cells having values equal to or larger than a specific threshold value regarding communication suitability, among measurement result values. However, the candidate cell list is not limited to cases in which cells have values equal to or larger than a specific threshold value, and may also refer to cases in which cells have values equal to or smaller than a specific threshold value, depending on the type of the specific threshold value.

In step 1050, the aerial UE may define a beam index with regard to the cell-specific reception beam used to measure the communication suitability of each cell. Each beam index may be defined according to a predefined rule. For example, the aerial UE may configure beams having the highest degree of similarity to be beams having adjacent index values. In an embodiment, the similarity between beams may be a beam shape-based similarity (for example, at least one of the similarity of spatial filter matrices or the similarity of generated beams in the transmission and/or reception direction). In an embodiment, the similarity between beams may similarity from the viewpoint of transmission and/or reception performance (for example, a case of having similar communication performances with regard to the same cell).

In step 1060, the aerial UE may report measurement information including communication suitability measurement result values to the base station. The measurement information may include beam index values regarding the aerial UE's beams used for measurement.

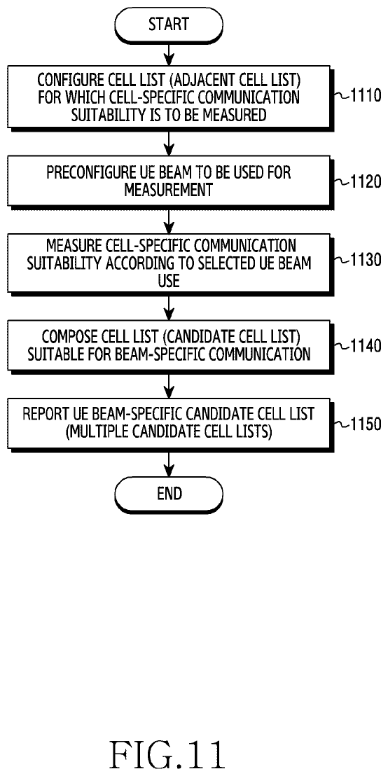

FIG. 11 illustrates the order in which an aerial UE reports indirect information regarding measurement cell-specific beams according to various embodiments of the disclosure.

Referring to FIG. 11, the order of operations of an aerial UE in which the aerial UE reports indirect information regarding beams to be used for communication with respective cells to a base station may be described.

In step 1110, the aerial UE may be configured to report communication suitability (for example, link quality) to a base station with regard to multiple cells for which communication suitability is to be measured. A cell list regarding multiple cells for which communication suitability is to be measured by the aerial UE may refer to a list of adjacent cells between which inter-cell interference may occur. In an embodiment, configurations for reporting communication suitability may be made by the base station through at least one of upper layer signaling (for example, RRC message) or MAC layer signaling (for example, MAC CE) or control information (for example, DCI). Information may be configured for the UE as a list of adjacent cells (for example, a list of candidate target cells to which the aerial UE is to hand over), and the list of adjacent cells may be determined by the base station. In an embodiment, the aerial UE may directly compose a list of adjacent cells for which communication suitability will be measured and reported. The aerial UE may transmit the composed list of adjacent cells to the base station.

In step 1120, the aerial UE may configure the aerial UE's beam to be used to measure communication suitability. The aerial UE may be configured to use a limited number of beams of the aerial UE, and the number of selected beams may be smaller than the number of cells configured to be measured by the UE. Configurations regarding the aerial UE's beam may be determined by the UE as desired, or may be made by the base station through at least one of upper layer signaling (for example, RRC message) or MAC layer signaling (for example, MAC CE) or control information (for example, DCI).

In step 1130, the aerial UE may measure communication suitability regarding adjacent cells configured in step 1110 by using respective beams configured in step 1120. For example, the aerial UE may measure and determine whether communication with each cell configured in step 1110 is possible or not, when a first beam is used, and may measure and determine whether communication with each cell configured in step 1110 is possible or not, when a second beam is used. The aerial UE may also determine communicable cells with regard to third and fourth beams, respectively.

In step 1140, the aerial UE may generate information regarding communicable cells when using respective beams configured in step 1120, based on the measurement and determination results in step 1130. In an embodiment, in case that the aerial UE is configured to use multiple beams in step 1120, multiple lists of communicable cells may be generated, one list for each beam. In an embodiment, the aerial UE may compose a list of communicable cells with regard to all beams configured in step 1120 or may compose a list of communicable cells with regard to only some beams. For example, the aerial UE may compose a list of communicable cells with regard to the first beam configured in step 1120, and may compose no list of communicable cells with regard to the second beam, separately from composition of the list of communicable cells with regard to the first beam.

In step 1150, the aerial UE may report the beam-specific cell list composed in step 1140 to the base station. The base station may assume that, in cells reported through the same cell list, communication is performed through the same beam of the aerial UE. For example, in case that communication is performed between the UE and one of cells included in a specific cell list, the aerial UE may assume that other cells reported through the same cell list may be heavily affected by inter-cell interference. In an embodiment, the aerial UE may transmit a report including the aerial UE's beam-specific candidate cell list information to the base station, and the report transmitted to the base station may include information regarding beams configured by the aerial UE. In an embodiment, the information regarding beams configured by the aerial UE may be reported separately from the report transmitted to the base station. In an embodiment, the information regarding beams configured by the aerial UE may not be reported to the base station.

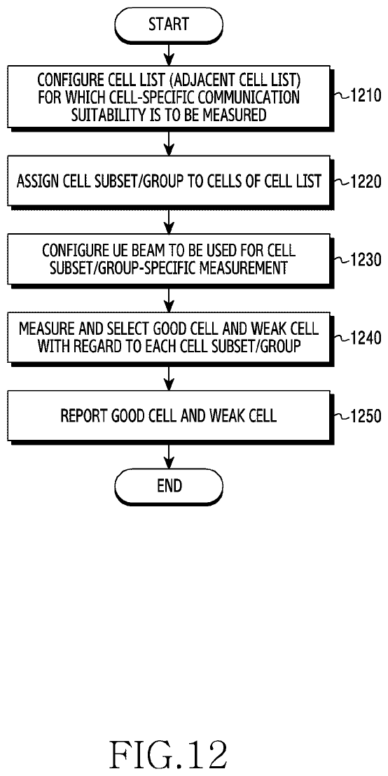

FIG. 12 illustrates the order in which an aerial UE reports indirect information regarding measurement cell-specific beams according to various embodiments of the disclosure.

Referring to FIG. 12, the order of operations of an aerial UE in which the aerial UE reports indirect information regarding beams to be used for communication with respective cells to a base station may be described. In the following description with reference to FIG. 12, descriptions overlapping those in FIG. 11 may be omitted.

In step 1210, the aerial UE may be configured to report communication suitability (for example, link quality) to a base station with regard to multiple cells for which communication suitability is to be measured. A cell list regarding multiple cells for which communication suitability is to be measured by the aerial UE may refer to a list of adjacent cells between which inter-cell interference may occur. In an embodiment, configurations for reporting communication suitability may be made by the base station through at least one of upper layer signaling (for example, RRC message) or MAC layer signaling (for example, MAC CE) or control information (for example, DCI). Information may be configured for the UE as a list of adjacent cells (for example, a list of candidate target cells to which the aerial UE is to hand over), and the list of adjacent cells may be determined by the base station. In an embodiment, the aerial UE may directly compose a list of adjacent cells for which communication suitability will be measured and reported. The aerial UE may transmit the composed list of adjacent cells to the base station.

In step 1220, with regard to multiple cells included in the adjacent cell list, cell subset information for reporting combination information to the aerial UE may be assigned by the base station. The cell subset may refer to a combination of two or more cells among multiple cells included in the adjacent cell list. The combination of two or more cells among multiple cells included in the adjacent cell list may also be referred to as a cell group. In case that there is no cell subset (or cell group) information, the aerial UE may assume that all cells configured in step 1210 belong to one cell subset (or cell group).

In step 1230, the aerial UE may configure the aerial UE's beams to be used to measure communication suitability with regard to each cell subset (or cell group) for which communication suitability is to be measured. The aerial UE may be configured to use a limited number of beams of the aerial UE, and the number of selected beams may be smaller than the number of cell subsets (or cell groups) configured to be measured by the UE. In addition, configurations regarding the aerial UE's beam may be determined by the UE as desired, or may be made by the base station through at least one of upper layer signaling (for example, RRC message) or MAC layer signaling (for example, MAC CE) or control information (for example, DCI). The aerial UE may determine good cells and weak cells through a comparison with a threshold value. For example, in case that the SINR of a specific cell is smaller than a specific threshold value, the aerial UE may determine that the cell is a weak cell. However, the weak cell determination is not limited to cases in which the SINR is smaller than the specific threshold value, and may include cases in which the SINR is equal to the specific threshold value.

In step 1240, the aerial UE may measure communication suitability regarding adjacent cells configured in step 1210 by using respective beams configured in step 1230. The aerial UE may also select good cells and weak cells with regard to each cell subset (or cell group). In connection with measuring and defining communication suitability with regard to multiple cells configured in step 1210, the aerial UE may define good cells and weak cells with regard to each cell subset or cell group configured in step 1220. A weak cell may refer to a cell which, in case that the aerial UE performs UE beamforming to communicate with a base station corresponding to a good cell, cannot efficiently transmit and/or receive signals through the corresponding beam. For example, a weak cell may refer to a cell which, in case that the aerial UE communicates with a cell or a base station corresponding to a good cell, is less affected by interference. In an embodiment, weak cells and good cells may be selected based on the same measurement value (for example, at least one of RSRP or SINR) indicating the link quality. In an embodiment, a separate reference signal may be configured for weak cell measurement. In case that a separate reference signal is configured for weak cell measurement, the aerial UE may select good cells and weak cells, based on different measurement values. For example, the aerial UE may select good cells, based on the RSRP which is one of measurement values indicating the link quality, and may then select weak cells, based on the signal to interference plus noise ratio (SINR) which is another measurement value indicating the link quality. The aerial UE may determine good cells and weak cells through a comparison with a link quality threshold value. For example, the aerial UE may measure interference which a specific cell with regard to a good cell through the SINR. A large SINR may mean that the corresponding cell generates a small amount of interference with regard to the good cell. Therefore, in case that the SINR is larger than a specific threshold value, the aerial UE may determine that the corresponding cell is a weak cell. However, the weak cell determination is not limited to cases in which the SINR is larger than the specific threshold value, and may include cases in which the SINR is equal to the specific threshold value. In an embodiment, the aerial UE may select good cells and weak cells with regard to each cell subset (or cell group) by using preconfigured beams, and may report information regarding good cells and weak cells selected with regard to each cell subset (or cell group) to the base station. The aerial UE may select at least one good cell and weak cell with regard to each cell subset (or cell group). Alternatively, the aerial UE may report that there is no good cell with regard to at least one cell subset (or cell group). Alternatively, the aerial UE may omit reporting of information regarding good cells and/or weak cells of at least one cell subset (or cell group). In an embodiment, the aerial UE may select a good cell and a beam to be used to communicate with the good cell, with regard to each cell subset (or cell group), by using a specific beam or multiple beams, may select a weak cell in case of using the selected beam, and may report information regarding the selected good cell and weak cell to the base station. The aerial UE may select multiple good cells with regard to a cell subset (or cell group), and may select different cells as weak cells with regard to each good cell. Therefore, the aerial UE may report a combination of at least one good cell and weak cell to the base station with regard to a cell subset (or cell group).

In step 1250, the aerial UE may transmit a measurement report including information regarding good cells and weak cells selected in step 1240 to the base station. In an embodiment, the measurement report may include information regarding the aerial UE's beam used to select good cells and weak cells. In an embodiment, the aerial UE may transmit a measurement report including only information regarding good cells and weak cells selected in step 1240 to the base station.

As described above, a method for operating a UE in a wireless communication system according to various embodiments disclosed herein may include a step of determining a list of at least one adjacent cell between which inter-cell interference may occur, and at least one beam for measuring the channel status regarding the at least one adjacent cell; a step of measuring the channel status regarding the at least one adjacent cell, based on the at least one beam; a step of selecting a candidate cell list, based on the measurement result value; and a step of transmitting a message including the candidate cell list and information regarding the at least one beam to a base station.

According to an embodiment, the method may further include a step of receiving the list of at least one adjacent cell and configuration information regarding the at least one beam from the base station. The configuration information may be configured for the UE through upper layer signaling.

According to an embodiment, each of the at least one beam may correspond to each of the at least one adjacent cell. The at least one beam corresponding to the at least one adjacent cell, respectively, may differ from each other. Information regarding the at least one beam may include at least one of information regarding the shape of different beams or information regarding the index thereof.

According to an embodiment, the method may further include a step of configuring at least one subset configured by a combination of the at least one adjacent cell, and a step of determining a first cell and a second cell, based on the channel status, with regard to each of the at least one subset. The channel status of the first cell may be equal to or higher than a specific threshold value, and channel status of the second cell may be lower than the specific threshold value.

According to an embodiment, the configuration information may include information regarding the at least one subset's configuration, and the information regarding the at least one beam may include information regarding the first and second cells.

As described above, a method for operating a base station in a wireless communication system according to various embodiments disclosed herein may include a step of transmitting a list of at least one adjacent cell between which inter-cell interference may occur, and configuration information regarding at least one beam for measuring the channel status regarding the at least one adjacent cell to a UE; and a step of receiving a candidate cell list and information regarding the at least one beam from the UE. The channel status regarding at least one adjacent cell may be measured based on the at least one beam, and the candidate cell list may be determined based on the measurement result value.

According to an embodiment, the configuration information may be configured for the UE through upper layer signaling.

According to an embodiment, each of the at least one beam may correspond to each of the at least one adjacent cell. The at least one beam corresponding to the at least one adjacent cell, respectively, may differ from each other. Information regarding the at least one beam may include at least one of information regarding the shape of different beams or information regarding the index thereof.

According to an embodiment, the configuration information may include information regarding the at least one subset. The at least one subset may be configured by a combination of the at least one adjacent cell. A first cell and a second cell may be determined, based on the channel status, with regard to each of the at least one subset. The channel status of the first cell may be equal to or higher than a specific threshold value. The channel status of the second cell may be lower than the specific threshold value.

According to an embodiment, the configuration information may include information regarding the at least one subset's configuration, and the information regarding the at least one beam may include information regarding the first and second cells.

As described above, a UE in a wireless communication system according to various embodiments disclosed herein may include at least one transceiver and at least one processor functionally coupled to the at least one transceiver. The at least one processor may configure a list of at least one adjacent cell between which inter-cell interference may occur, and at least one beam for measuring the channel status regarding the at least one adjacent cell; may measure the channel status regarding the at least one adjacent cell, based on the at least one beam; may determine a candidate cell list, based on the measurement result value; and may transmit the candidate cell list and information regarding the at least one beam to a base station.

According to an embodiment, the at least one processor may receive the list of at least one adjacent cell and configuration information regarding the at least one beam from the base station. The configuration information may be configured for the UE through upper layer signaling.

According to an embodiment, each of the at least one beam may correspond to each of the at least one adjacent cell. The at least one beam corresponding to the at least one adjacent cell, respectively, may differ from each other. Information regarding the at least one beam may include at least one of information regarding the shape of different beams or information regarding the index thereof.

As described above, the at least one processor according to various embodiments disclosed herein may configure at least one subset configured by a combination of the at least one adjacent cell, and may determine a first cell and a second cell, based on the channel status, with regard to each of the at least one subset. The channel status of the first cell may be equal to or higher than a specific threshold value, and channel status of the second cell may be lower than the specific threshold value.

According to an embodiment, the configuration information may include information regarding the at least one subset's configuration, and the information regarding the at least one beam may include information regarding the first and second cells.

As described above, a base station in a wireless communication system according to various embodiments disclosed herein may include at least one transceiver and at least one processor functionally coupled to the at least one transceiver. The at least one processor may transmit a list of at least one adjacent cell between which inter-cell interference may occur, and configuration information regarding at least one beam for measuring the channel status regarding the at least one adjacent cell to a UE; and may receive a candidate cell list and information regarding the at least one beam from the UE. The channel status regarding at least one adjacent cell may be measured based on the at least one beam, and the candidate cell list may be determined based on the measurement result value.

According to an embodiment, the configuration information may be configured for the UE through upper layer signaling.

According to an embodiment, each of the at least one beam may correspond to each of the at least one adjacent cell. The at least one beam corresponding to the at least one adjacent cell, respectively, may differ from each other. Information regarding the at least one beam may include at least one of information regarding the shape of different beams or information regarding the index thereof.

According to an embodiment, the configuration information may include information regarding the at least one subset. The at least one subset may be configured by a combination of the at least one adjacent cell. A first cell and a second cell may be determined, based on the channel status, with regard to each of the at least one subset. The channel status of the first cell may be equal to or higher than a specific threshold value. The channel status of the second cell may be lower than the specific threshold value.

According to an embodiment, the configuration information may include information regarding the at least one subset's configuration, and the information regarding the at least one beam may include information regarding the first and second cells.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the 5G or NR system, other variants based on the technical idea of the embodiments may also be implemented in other communication systems such as LTE or LTE-A systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1-15. (canceled)

16. A method performed by a terminal in a wireless communication system, the method comprising:
receiving, from a base station, first configuration information on a reference signal, RS, and second configuration information for a measurement report; and
transmitting, to the base station, the measurement report including information on at least one candidate cell and information on at least one RS for the at least one candidate cell, based on the second configuration information,
wherein the at least one candidate cell is measured based on the first configuration information.

17. The method of claim 16, wherein the first configuration information includes at least one of an index of the at least one RS or information on a type for the at least one RS.

18. The method of claim 16, wherein the at least one RS corresponds to a candidate cell.

19. The method of claim 16, wherein the measurement report includes information on a channel status for the at least one candidate cell.

20. A method performed by a base station in a wireless communication system, the method comprising:
transmitting, to a terminal, first configuration information on a reference signal, RS, and second configuration information for a measurement report; and
receiving, from the terminal, the measurement report including information on at least one candidate cell and information on at least one RS for the at least one candidate cell, based on the second configuration information,
wherein the at least one candidate cell is based on the first configuration information.

21. The method of claim 20, wherein the first configuration information includes at least one of an index of the at least one RS or information on a type for the at least one RS.

22. The method of claim 20, wherein the at least one RS corresponds to a candidate cell.

23. The method of claim 20, wherein the measurement report includes information on a channel status for the at least one candidate cell.

24. A terminal in a wireless communication system, the terminal comprising:
a transceiver; and
at least one controller coupled with the transceiver and configured to:
receive, from a base station, first configuration information on a reference signal, RS, and second configuration information for a measurement report, and
transmit, to the base station, the measurement report including information on at least one candidate cell and information on at least one RS for the at least one candidate cell, based on the second configuration information,
wherein the at least one candidate cell is measured based on the first configuration information.

25. The terminal of claim 24, wherein the first configuration information includes at least one of an index of the at least one RS or information on a type for the at least one RS.

26. The terminal of claim 24, wherein the at least one RS corresponds to a candidate cell.

27. The terminal of claim 24, wherein the measurement report includes information on a channel status for the at least one candidate cell.

28. A base station in a wireless communication system, the base station comprising:
a transceiver; and
at least one controller coupled with the transceiver and configured to:
transmit, to a terminal, first configuration information on a reference signal, RS, and second configuration information for a measurement report, and
receive, from the terminal, the measurement report including information on at least one candidate cell and information on at least one RS for the at least one candidate cell, based on the second configuration information,
wherein the at least one candidate cell is based on the first configuration information.

29. The base station of claim 28, wherein the first configuration information includes at least one of an index of the at least one RS or information on a type for the at least one RS.

30. The base station of claim 28, wherein the at least one RS corresponds to a candidate cell.

31. The base station of claim 28, wherein the measurement report includes information on a channel status for the at least one candidate cell.
